(19) United States
(12) Patent Application Publication
(10) Pub. No.: US 2025/0112587 A1
(43) Pub. Date: Apr. 3, 2025

(54) SMALL ANGLE TILTING TO APPROXIMATE VERTICAL SOLAR ARRAYS AND PROVIDE ENHANCED ENERGY YIELD

(71) Applicant: Rutgers, The State University of New Jersey, New Brunswick, NJ (US)

(72) Inventor: Dunbar Birnie, New Brunswick, NJ (US)

(73) Assignee: Rutgers, The State University of New Jersey, New Brunswick, NJ (US)

(21) Appl. No.: 18/899,897

(22) Filed: Sep. 27, 2024

Related U.S. Application Data
(60) Provisional application No. 63/541,027, filed on Sep. 28, 2023.

(51) Int. Cl. H02S 20/32; H02S 40/22

(52) U.S. Cl. CPC H02S 20/32; H02S 40/22

(57) ABSTRACT

A tiltable near-vertical bifacial (TNVBF) solar panel assembly comprising one or more BF solar panels configured to be positioned in a first (AM) tilt position to improve energy conversion of morning sunlight incident upon a first side of the one or more BF solar panels, and to be positioned in a second (PM) tilt position to improve energy conversion of afternoon sunlight incident upon a second side of the one or more BF solar panels.

### CROSS-REFERENCE TO RELATED APPLICATION(S)

This application claims the benefit of U.S. Provisional Patent Application Ser. No. 63/541,027 filed Sep. 28, 2023, which Application is incorporated herein by reference in its entirety.

### FIELD OF THE DISCLOSURE

The present disclosure generally relates to solar arrays and, in particular, to efficient mechanisms for improving energy yield of bifacial solar array panels while maintaining useful accessibility to the land for agricultural operations.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Solar modules are mass-produced commodity wares at this point and have been optimized for use in normal “fixed tilt” installations that can be 100s of acres in expanse, where the land is ONLY used for solar production and prior agricultural use has been implicitly abandoned. While this enables vast tracts of land to generate giga-watthours of green energy, there is a growing movement trying to establish solar and agricultural modes where BOTH solar energy and agricultural production are retained. This thrust is known as “Agrivoltaics,” and it typically involves some level of compromise of both solar and agricultural use or yields so that taken together it is a win-win for society.

One mode of agrivoltaics is to use “bifacial” solar modules which can absorb light from the front AND the back of the modules—and to install them vertically so that their front face receives bright sunlight from the east in the morning and their back face receives bright sunlight from the west in the afternoon, such as depicted in FIG. 1. Such vertical bi-facial (VBF) installations are typically installed as a number of rows running generally north-to-south allowing AM sunlight to hit one side and PM sunlight to hit the other side. While these installations provide accessibility for agriculture the annual energy production is lower than compared with fixed position or single-axis tracking arrays.

### SUMMARY

Various embodiments comprise systems, methods, architectures, mechanisms and apparatus providing a tiltable near-vertical bifacial (TNVBF) solar panel assembly comprising one or more BF solar panels configured to be positioned in a first (AM) tilt position to improve energy conversion of morning sunlight incident upon a first side of the one or more BF solar panels, and to be positioned in a second (PM) tilt position to improve energy conversion of afternoon sunlight incident upon a second side of the one or more BF solar panels.

Various embodiments provide a tiltable near-vertical bifacial (TNVBF) solar panel assembly comprising one or more bifacial (BF) solar panels pivotally attached to a common mount rotatably controlled by a motor so as to cause the BF solar panels to move between a first tilt position and a second tilt position, the first tilt position configured to increase an angle of incidence of sunlight upon a first face of the BF solar panels, the second tilt position configured to increase an angle of incidence of sunlight upon a second face of the BF solar panels.

The first tilt position may be selected to improve energy conversion of morning sunlight incident upon the one or more BF solar panels, and the second tilt position may be selected to improve energy conversion of afternoon sunlight incident upon the one or more BF solar panels. The first and second tilt positions may be approximately 15 degrees from vertical, 25 degrees from vertical, or some other angle from vertical. The first and second tilt positions may tilt from vertical by the same angle or by different angles. The first tilt angle and second tilt angle, whether the same or different from each other, may be fixed throughout the year or change periodically, such as for winter/summer, for each of the four seasons, for each month, for different latitudes of solar panel installation, and so on.

The BF solar panels may be positioned in the first tilt position prior to dawn and positioned in the second tilt position at a time when energy conversion of sunlight incident upon the second face of the BF solar panels in the second tilt position is determined to exceed energy conversion of sunlight incident upon the first face of the BF solar panels in the first tilt position.

The assembly may comprise a tiltable near-vertical bifacial (TNVBF) solar panel assembly disposed above a vertical bifacial (VBF) assembly to form thereby a hybrid assembly.

The assembly may further comprise one or more reflectors positioned to extend outward from a base region of the BF solar panel at an acute angle with respect to the BF solar panel.

Various embodiments comprise systems, methods, architectures, mechanisms and apparatus attaching reflectors to non-tilting vertical BF solar panel assembly comprising one or more BF solar panels achieving greater sunlight capture from additional sunlight or glare reflected from the solar panel glass surfaces.

The assembly may further comprise one or more reflectors positioned to extend outward from a base region of the BF solar panel at an acute angle with respect to the BF solar panel that have motorized or adjustable tilt angles for improved sunlight capture through the day.

Additional objects, advantages, and novel features of the invention will be set forth in part in the description which follows and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a prior art vertical bifacial (VBF) assembly;

FIG. 2 illustrates a problem with the VBF assembly of FIG. 1;

FIGS. 3A and 3B graphically depict scatterplots of Direct Irradiance as a function of alignment of the sun's rays for, respectively, a standard fixed-tilt array and a conventional VBF array;

FIG. 3C graphically depicts a scatterplot of Direct Irradiance as a function of alignment of the sun's rays for a tiltable near-vertical bifacial (TNVBF) array according to an embodiment;

FIGS. 4A and 4B illustrate side views of a tiltable near-vertical bifacial (TNVBF) panel assembly configured for, respectively, morning (AM) operation and afternoon (PM) operation;

FIG. 5 depicts a perspective view of a TNVBF panel assembly employing single axis tilting;

FIG. 6 illustrates a side view of a hybrid TNVBF and VBF panel assembly; and

FIG. 7 illustrates a side view of the tiltable near-vertical bifacial (TNVBF) panel assembly of FIG. 4 configured to further include one or more side reflectors.

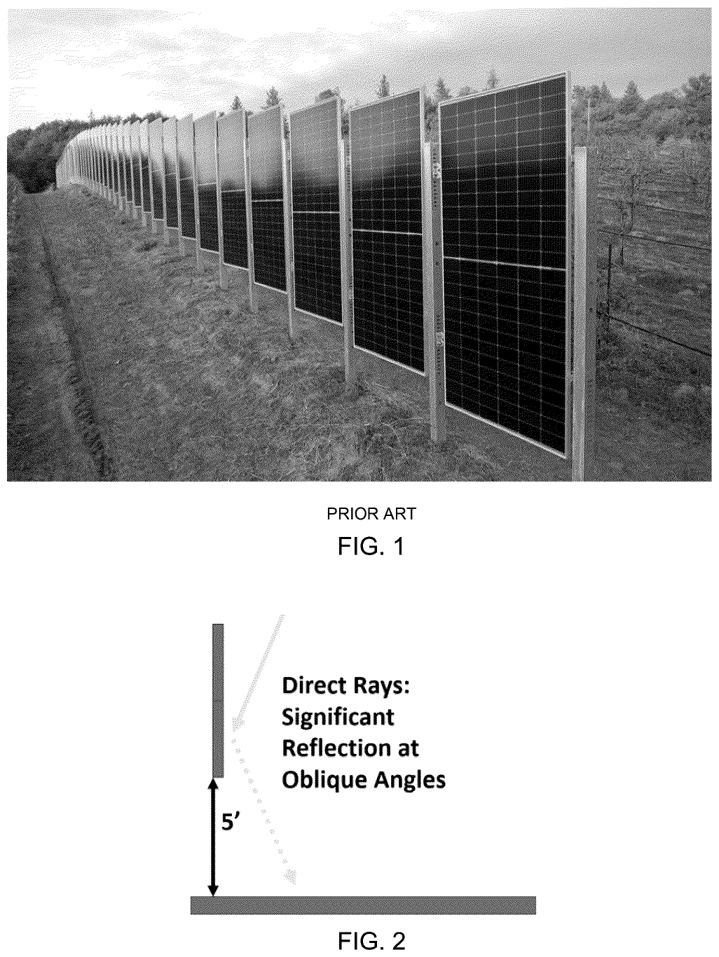

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various embodiments provide improved solar arrays and installations or systems thereof using what the inventor has denoted as tiltable near-vertical bifacial (TNVBF) solar panel assemblies. The TNVBF panel assemblies provide a specific limited motion tilt similar to tracking of the panels during the day so as to achieve better annual energy yield. That is, small but well considered changes in the positioning or angle of TNVBF panels with respect to the sun at different portions of the day are provided so as to improve energy yield of the TNVBF solar arrays. These small angle variations allow improved energy yield without additional compromising farming equipment access.

FIG. 2 illustrates a problem with the VBF installations. Specifically, the brightest parts of the day are near noon, plus or minus 3 hours or so. These are times when the sun is quite high in the sky and, therefore, the incoming direct solar rays incident upon the VBF are at a relatively glancing angle with respect to the surface of the VBF, which yields a reduced absorption of energy by the array installation. These glancing angles have two negative consequences: first, the glass front surface of the solar module may be reflecting too much light, which reflected light has no chance of being absorbed by the semiconductor wafer at the interior of the solar module, and second the glancing angle reduces the geometric cross-sectional area by a factor of cosine (theta) the also reduces the energy production.

Various embodiments address this issue such as via a motorized tracking program that can be added to enhance the sunlight capture during these midday time periods while still keep the main VBF advantages.

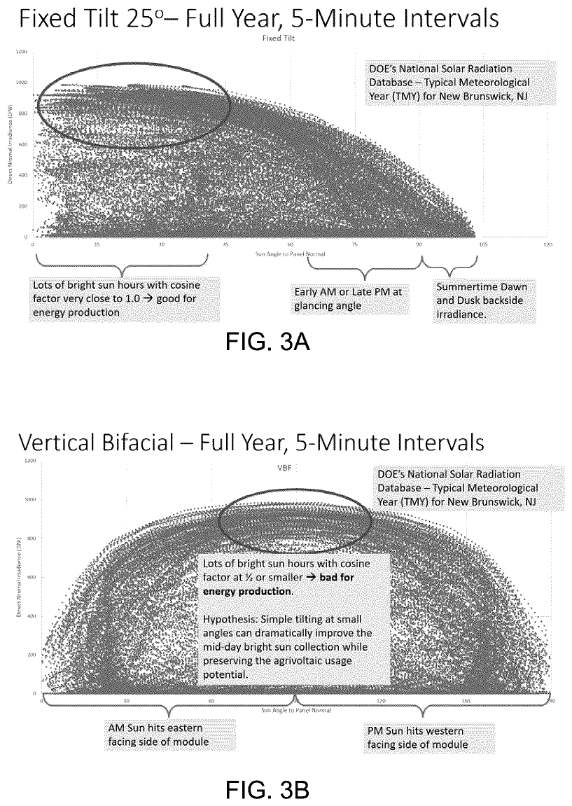

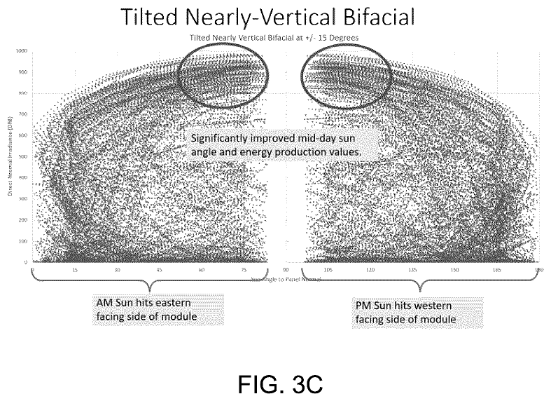

FIGS. 3A and 3B graphically depict scatterplots of Direct Irradiance as a function of alignment of the sun's rays for, respectively, a standard fixed-tilt array and a conventional VBF array. It can be seen that FIGS. 3A-3B show a diminution of Direct Irradiance at certain times and dates (e.g., early morning and late afternoon, and summertime dawn/dusk) that is not experienced by the VBF array.

FIG. 3C graphically depicts a scatterplot of Direct Irradiance as a function of alignment of the sun's rays for a tiltable near-vertical bifacial (TNVBF) array according to an embodiment. This graphic shows that sun locations near mid-day have now been moved (either positively or negatively) to positions with greater cosine (theta) values and therefore greater direct irradiance on the BF module faces, thus increasing energy capture.

Various embodiments contemplate a TNVBF array that, rather than being configured in a fixed vertical position, is instead configured to slightly tilt in one direction during an early part of the day and in the other direction during a later part of the day. In this manner, the incident angle of sunlight upon the front and back surfaces of the TNVBF panel is improved.

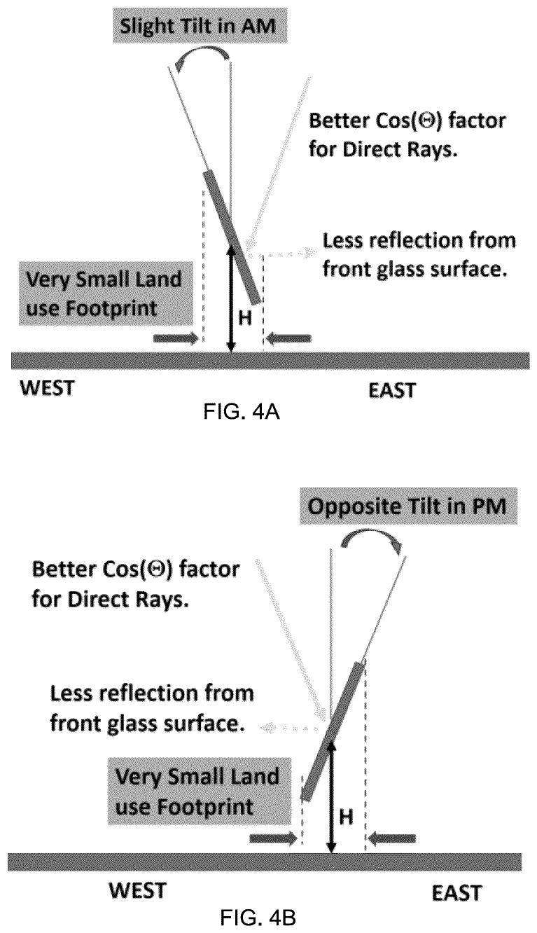

FIGS. 4A and 4B illustrate side views of a TNVBF panel assembly configured for, respectively, morning (AM) operation and afternoon (PM) operation. Specifically, a TNVBF panel comprising energy absorbing semiconductor(s) receives light through either an east-facing glass panel or a west-facing glass panel. As depicted in FIG. 4A, during a portion of the morning the TNVBF panel is tilted slightly counterclockwise (west) to enable more direct incident AM sunlight upon the east-facing panel (more direct results in less reflection). As depicted in FIG. 4B, at a certain time the TNVBF panel is tilted slightly clockwise (east) to enable more direct incident PM sunlight upon the west-facing panel. This tilting of panels reduces reflection losses and improves the projected area and amount of light captured by the modules. Morning tilts to favor sun coming from the east (right) and afternoon uses an opposite tilt to favor rays coming from the west (left).

In various embodiments, the tilt positions (e.g., AM and PM) may be selected based upon calculations of position of the sun and expected maximum energy conversion of sunlight (i.e., optimizing positions for maximum energy over the course of a morning via a first side of a BF panel, and over the course of an afternoon via a second side of the BF panel).

In various embodiments, the tilt positions and/or the time when such positions are changed further depends upon the efficiency of the AM side of the TNVBF panel vs the PM side of the TNVBF panel. For example, if the AM and PM sides are equally efficient, then a calculated midpoint time based upon incident angle of the sun may be used (optionally offset by a latitude consideration). Where the AM side of the TNVBF panel is more efficient that the PM side, the timing of the tilting of the panel is adjusted to account for this difference such that the panel is tilted at approximately the time where the PM side efficiency approximates the AM side efficiency.

As shown in FIGS. 4A-4B, tilting is mechanically supported by a pivot point at a height H as shown in the figures, illustratively at a substantially central portion of the TNVBF panel such that the weight of the panel is somewhat balanced, and the force needed to effectuate the tilting motion is minimized. In various embodiments, the pivot or attachment point is at some other height (i.e., above or below the central portion of the TNVBF panel).

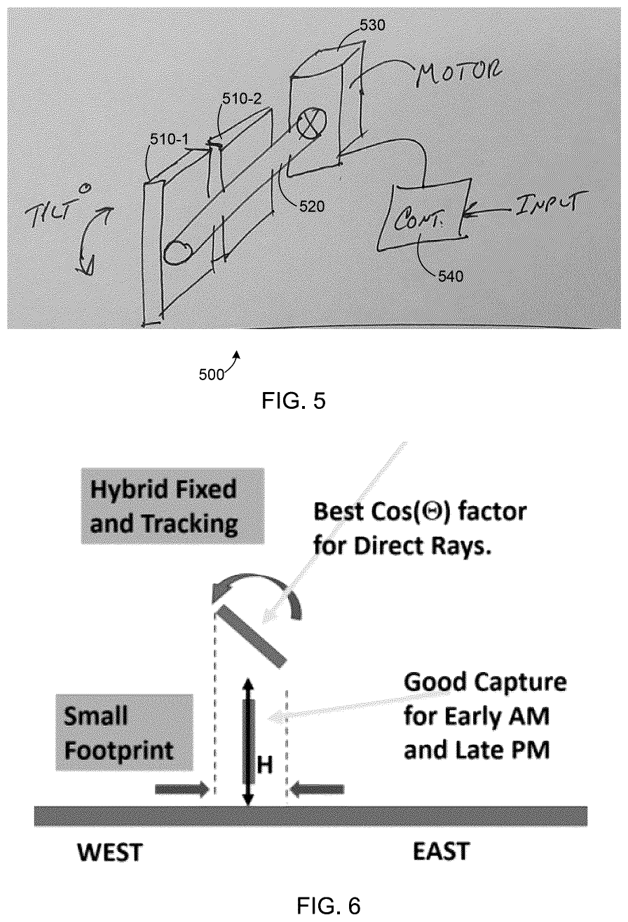

FIG. 5 depicts a perspective view of a TNVBF panel assembly employing single axis tilting. Specifically, FIG. 5 depicts a plurality of TNVBF panels 510-1 through 510-2 (more or fewer may be used) mounted to a common horizontal member 520 which is subjected to axial rotation by a motor 530 such that all TNVBF panels 510 in the assembly 500 are pivoted or tilted at the same time. The amount of tilt may be defined in terms of several tilt positions; namely, AM and PM (optionally, protection or storm storage position), such as described herein with respect to the various figures. However, in various other embodiments, the amount of tilt may be defined in terms of multiple tilt positions or by specific angles and the like. By using a single axis tilting system, the BF panels may be kept in a nearly upright or profile position to thereby maximize access to the ground such as for farming purposes.

In various embodiments, different mechanisms for inducing tilt may be employed to impart tilt to the TNVBF panels, such as actuators (e.g., solenoids), hydraulic elements, motors, gears, and/or levers of various types configured to induce the appropriate tilt for one or more of the TNVBF panels in the TNVBF panel array.

It is noted that the range of the tilting angle may be increased or decreased as desired. A larger range of tilt will increase the energy yield of the TNVBF panels but will lead the panel rows to extend further outward so as to occupy a wider space and possibly impede the operation of farm equipment or reduce the effectiveness of the vertical rows to act as fencing.

Various embodiments provide, for example, a tiltable near-vertical bifacial (TNVBF) solar panel assembly comprising one or more bifacial (BF) solar panels pivotally attached to a common mount rotatably controlled by a motor so as to cause the BF solar panels to move between a first tilt position and a second tilt position, the first tilt position configured to increase an angle of incidence of sunlight upon a first face of the BF solar panels, the second tilt position configured to increase an angle of incidence of sunlight upon a second face of the BF solar panels.

The first tilt position may be selected to improve energy conversion of morning sunlight incident upon the one or more BF solar panels, and the second tilt position may be selected to improve energy conversion of afternoon sunlight incident upon the one or more BF solar panels. The first and second tilt positions may be approximately 15 degrees from vertical, 25 degrees from vertical, or some other angle from vertical. The first and second tilt positions may tilt from vertical by the same angle or by different angles. The first tile angle and second tilt angle, whether the same or different from each other, may be fixed throughout the year or change periodically, such as for winter/summer, for each of the four seasons, for each month, for different latitudes of solar panel installation, and so on.

The BF solar panels may be positioned in the first tilt position prior to dawn and positioned in the second tilt position at a time when energy conversion of sunlight incident upon the second face of the BF solar panels in the second tilt position is determined to exceed energy conversion of sunlight incident upon the first face of the BF solar panels in the first tilt position.

The assembly may comprise a tiltable near-vertical bifacial (TNVBF) solar panel assembly disposed above a vertical bifacial (VBF) assembly to form thereby a hybrid assembly, such as will now be discussed with respect to FIG. 6.

FIG. 6 illustrates a side view of a hybrid TNVBF and VBF panel assembly. Specifically, the hybrid panel assembly 600 of FIG. 6 includes upper TNVBF panels and lower VBF panels, wherein the lower VBF panels are fixed (illustratively vertical or at a slight angle depending upon installation latitude), and the upper TNVBF panels are controlled in a manner similar to that of the fully tiltable assembly 400 of FIGS. 4A-4B. Advantageously, the hybrid tiltable TNVBF and VBF panel assembly 600 of FIG. 6 allows for an increased tilt angle of the upper TNVBF panels without impeding access to the ground if the upper TNVBF panels are smaller than lower VBF panels such as provided by the assembly 400 of FIGS. 4A-4B, and/or if the upper TNVBF panels are mounted high enough to allow for equipment to pass unimpeded underneath.

In various embodiments, the hybrid TNVBF and VBF panel assembly 600 of FIG. 6 comprises either or both of landscape-oriented panels (width greater than height) and portrait-oriented panels (height greater than width) in any combination. For example, the bottom/lower panels may comprise either landscape-oriented or profile-oriented fixed position bi-facial panels such as VBF panels, while the upper/top TNVBF panels may comprise either or both of landscape-oriented or profile-oriented TNVBF panels.

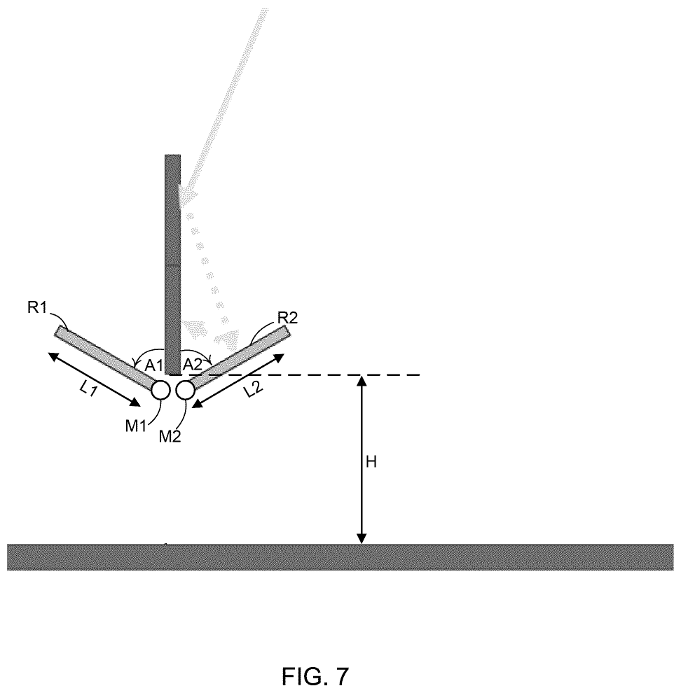

FIG. 7 illustrates a side view of the tiltable near-vertical bifacial (TNVBF) panel assembly of FIG. 4 configured to further include one or more side reflectors. Specifically, FIG. 7 depicts a vertically oriented bifacial (BF) solar panel, illustratively as depicted above with respect to the various TNVBF panel assemblies described herein, wherein each of two side reflectors R1 and R2 (illustratively, substantially planar reflectors) of respective lengths L1 and L2 (which lengths may be the same or different) are positioned to extend outward from a base region (i.e., lower portion) of the BF solar panel at respective acute angles A1 and A2 with respect to the BF solar panel (which angles may be the same or different). The angles A1/A2 and lengths L1/L2 of the reflectors R1/R2 are sized in accordance with the height of the BF solar panel, the amount of space available on one or both sides of the BF solar panel when the TNVBF assembly is installed, the incident angle of the sun on the BF solar panel at maximum brightness, and so on. Generally speaking, the lengths L1 and L2 will be less than half the height of the BF solar panel, and the angles A1 and A2 comprise acute angles with respect to the vertically oriented BF solar panel of the TNVBF assembly, ranging from approximately 15 degrees to approximately 75 degrees therefrom.

The angles A1 and A2 may be fixed or adjustable, such as via motors M1 and M2. For example, the reflectors may be fixed with respect to the TNVBF or may be configured to move with the TNVBF (e.g., such that the reflectors move or even tilt when the main BF modules are tilting).

The purpose of the side reflectors is to capture additional solar radiation from two sources: (1) they redirect solar radiation reflected by upper portions of the BF solar panel (e.g., due to a relatively low incidence angle of solar radiation upon the panel) toward lower portions of the BF solar panel, such as depicted in FIG. 7; and (2) there are cases where sunlight might first hit the reflector and be aimed at the vertical or nearly-vertical panel. In this manner, more of the available solar energy may be captured during the time of day associated with the combined assembly receiving low incidence angle solar radiation (e.g., near midday).

It is noted that the embodiments of FIG. 7 may be used with respect to fixed vertical solar panels or articulating solar panels such as the BF solar panel and TNVBF assemblies described above with respect to the various figures.

It is further noted that the embodiments of FIG. 7 may comprise one or more side reflectors (two reflectors are shown). Further, the one or more side reflectors may comprise substantially planar reflectors as shown, or reflectors having a concave, convex, or other surface geometry.

As shown in FIG. 7, a gap between the side reflector(s) and the vertically oriented BF solar panel may be provided to allow for leaves and other debris to fall to the ground rather than accumulate on the side reflectors or at the mounting point(s) thereof. Preferably the side reflector(s) would not extend too far outward so as to ensure that the land between rows of solar assemblies remains accessible to farm equipment and operations.

Further, in various embodiments the side reflector(s) of FIG. 7 may themselves be controllably tilted by one or more motors M2 and/or M2, such as shown in FIG. 7 wherein motors M1/M2 may be implemented and configured in a manner similar to that described above with respect to the motors of FIG. 5 so as to controllably adjust one or both angles A1, A2 of the BF solar panel of the TNVBF assembly. That is, M1 and M2 may comprise any mechanism for imparting the appropriate tilt or angle to the side reflectors, such as actuators (e.g., solenoids), hydraulic elements, motors, gears, and/or levers of various types configured to induce the appropriate tilt for one or more of the TNVBF panels in the TNVBF panel array.

Thus, in some embodiments a TNVBF solar panel assembly as described above has one or more side reflectors.

In some embodiments, the one or more side reflectors are set to fixed positions.

In some embodiments, the one or more side reflectors are pivotally attached to the same common mount as the one or more BF solar panels of the TNVBF assembly so as to cause the one or more side reflectors to maintain respective angles A1 and/or A2 irrespective of the tilt of the one or more BF solar panels.

In some embodiments, the one or more side reflectors are pivotally attached to a second common mount rotatably controlled by a respective second motor (e.g., M1 and/or M2) so as to cause the one or more side reflectors to move between respective angles A1 and/or A2 independently of the tilt of the one or more BF solar panels.

In various embodiments, the TNVBF panel assemblies or portions thereof of FIGS. 4A-4B or FIG. 6-7 may be configured to have a “stow” position which will cause the panels to tilt to a specific protective angle selected to avoid wind damage.

Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A tiltable near-vertical bifacial (TNVBF) solar panel assembly, comprising:
one or more bifacial (BF) solar panels pivotally attached to a common mount rotatably controlled by a motor so as to cause the BF solar panels to move between a first tilt position and a second tilt position, the first tilt position configured to increase an angle of incidence of sunlight upon a first face of the BF solar panels, the second tilt position configured to increase an angle of incidence of sunlight upon a second face of the BF solar panels.

2. The TNVBF solar panel assembly of claim 1, wherein the first tilt position is selected to improve energy conversion of morning sunlight incident upon the one or more BF solar panels, and the second tilt position is selected to improve energy conversion of afternoon sunlight incident upon the one or more BF solar panels.

3. The TNVBF solar panel assembly of claim 2, wherein the first and second tilt positions are approximately 15 degrees from vertical.

4. The TNVBF solar panel assembly of claim 2, wherein the first and second tilt positions are within approximately 25 degrees from vertical.

5. The TNVBF solar panel assembly of claim 2, wherein the one or more BF solar panels are positioned in the first tilt position prior to dawn and positioned in the second tilt position at a time when energy conversion of sunlight incident upon the second face of the BF solar panels in the second tilt position is determined to exceed energy conversion of sunlight incident upon the first face of the BF solar panels in the first tilt position.

6. The TNVBF solar panel assembly of claim 1, wherein the tiltable near-vertical bifacial (TNVBF) solar panel assembly is disposed above a vertical bifacial (VBF) assembly to form thereby a hybrid assembly.

7. The TNVBF solar panel assembly of claim 1, further comprising a pair of reflectors positioned to extend outward from each side of a base region of the BF solar panel at acute angles with respect to the BF solar panel.

8. The TNVBF solar panel assembly of claim 1, further comprising at least one reflector positioned to extend outward from a base region of the BF solar panel at an acute angle with respect to the BF solar panel.

9. The TNVBF solar panel assembly of claim 8, wherein the at least one reflector comprises a reflector having a substantially planar surface.

10. The TNVBF solar panel assembly of claim 8, wherein the at least one reflector comprises a reflector having a substantially concave surface.

11. The TNVBF solar panel assembly of claim 8, wherein the at least one reflector comprises a reflector having a substantially convex surface.

12. The TNVBF solar panel assembly of claim 8, wherein the at least one reflector is pivotally attached to the same common mount as the one or more BF solar panels.

13. The TNVBF solar panel assembly of claim 8, wherein the at least one reflector is pivotally attached to a second common mount rotatably controlled by a second motor so as to cause the BF solar panels to move between a first tilt position and a second tilt position.
